(19) United States
(12) Patent Application Publication
(10) Pub. No.: US 2025/0385516 A1
(43) Pub. Date: Dec. 18, 2025

(54) POWER GRID LOAD CONTROL

(71) Applicant: Alarm.com Incorporated, Tysons, VA (US)

(72) Inventor: Alexander Lawrence Reeder, Ridgefield, CT (US)

(21) Appl. No.: 19/202,174

(22) Filed: May 8, 2025

Related U.S. Application Data
(60) Provisional application No. 63/659,906, filed on Jun. 14, 2024.

(51) Int. Cl. H02J 3/00; H02J 3/38

(52) U.S. Cl. CPC H02J 3/0012; H02J 3/381; H02J 2203/20; H02J 2300/40; H02J 2310/14

(57) ABSTRACT

Methods, systems, and apparatus, including computer programs encoded on computer storage media, for power grid load control. One of the methods includes receiving, from a sensor of a load control unit located at a property, power grid frequency data indicating a locally measured power grid frequency at the property, determining, from the power grid frequency data, a grid frequency event, and in response to the determined grid frequency event, generating, by the load control unit, control signals to adjust a setting of a load in data communication with the load control unit within a threshold distance of the property.

### CROSS-REFERENCE TO RELATED APPLICATIONS

This application claims the benefit of priority to U.S. Provisional Application No. 63/659,906, filed on Jun. 14, 2024, the contents of which are hereby incorporated by reference.

### BACKGROUND

In an electric grid, the nominal operating frequency (e.g., 60 Hz or 50 Hz) must be maintained precisely to protect equipment and ensure proper operation of the system. When the grid becomes overloaded, the frequency of the grid droops by several tenths of a Hz. If there is an unexpected loss of generation, the frequency can drop very rapidly and requires immediate mitigating actions to prevent damage. For this reason, power generators can employ AGC (automatic generation control) technologies to precisely measure frequency and automatically react to the frequency and rate-of-change-of-frequency (ROCOF) to ramp up or down generation to try to bring the grid back into balance at the nominal operating frequency.

### SUMMARY

As the world turns toward renewable energy sources to meet its future power generation needs, the need for additional grid-balancing resources will increase. Wind and solar energy are expected to comprise a large portion of the new global electricity generation over the next decade. These generators are known as inverter-based resources (IBR's) and cannot be ramped up and down by operators like traditional thermal generators. When solar and wind resources produce energy, the grid must adapt to that generation to maintain grid stability.

This specification describes technologies for locally monitoring and responding to fluctuations in grid stability using fast frequency response (FFR). These technologies generally involve a local load control unit, e.g., a thermostat, that can locally measure grid frequency at a property and react to out-of-bounds values by applying a set point offset or mode change that can immediately alter, e.g., turn off, connected appliance load connected to the local load control unit, e.g., a property monitoring device. For example, in the instance of a thermostat, the thermostat locally measures grid frequency for the property at which the thermostat is installed and reacts to out-of-bounds values by providing control signals to the load to alter a set point offset or mode of operation to turn off an HVAC load connected to the thermostat.

In some implementations, the local load control unit conveys the detected grid frequency event to other load control units, e.g., other devices at the property that do not measure grid frequency. In some examples, the local load control unit can convey the detect grid frequency event to a back-end system of a grid supportive system, e.g., one or more cloud-based servers that monitor and respond to grid events for one or more power grids. For example, the grid supportive system can use the grid frequency event information from one or more local load control units to trigger an automated load control response, e.g., at other properties.

In general, the local load control unit can detect and respond to grid frequency events using a set of event criteria implementable, for example, as a set of rules, an automated load control (ALC) response model, or a combination of both. In response to a grid frequency event meeting a set of event criteria, the local load control unit triggers a response. The set of event criteria can allow the local load control unit to react to a detected grid frequency event in a highly predictable manner, even without network connectivity to a central grid supportive system.

In general, one innovative aspect of the subject matter described in this specification can be embodied in a system including one or more computers and one storage devices on which are stored instructions that are operable, when executed by the one or more computers, to cause the one or more computers to perform operations including receiving, from a sensor of a load control unit located at a property, power grid frequency data indicating a locally measured power grid frequency at the property, determining, from the power grid frequency data, a grid frequency event, and in response to the determined grid frequency event, the load control unit generates control signals to adjust a setting of a load in data communication with the load control unit within a threshold distance of the property.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, receiving, from the sensor of the load control unit located at the property, the power grid frequency data includes receiving, from a sensor of a thermostat of the property, the power grid frequency data, and where adjusting the setting of the load control unit includes adjusting the setting of the thermostat.

In some implementations, adjusting the setting of the thermostat further includes generating, from the setting of the thermostat, control signals to adjust a set point offset or a mode of operation of an HVAC system in data communication with the thermostat, and providing, to the HVAC system, the control signals.

In some implementations, determining the grid frequency event includes determining that the locally measured power grid frequency does not satisfy a frequency threshold value, and where adjusting the setting is responsive to determining that the locally measured power grid frequency does not satisfy the frequency threshold value.

In some implementations, the power grid frequency data includes a rate of change of frequency (ROCOF) value, determining the grid frequency event includes determining that the ROCOF value does not satisfy a threshold ROCOF value, and adjusting the setting of the load control unit at the property is responsive to determining that the ROCOF value does not satisfy the threshold ROCOF value.

In some implementations, the operations of the system further include generating an alert responsive to the grid frequency event, and providing, to one or more other load control units in a threshold vicinity of the sensor at the property, the alert responsive to the grid frequency event. Providing the alert responsive to the grid frequency event can include triggering an automated load control event for the one or more other load control units in the threshold vicinity of the sensor at the property including adjusting respective settings of each of the one or more other load control units.

In some implementations, at least one of the one or more other load control units are located at a different property within the threshold vicinity of the property.

In some implementations, the operations of the system further include transmitting, to each of the one or more other load control units in the threshold vicinity of the sensor at the property, instructions to cause the other load control unit to perform an adjustment to a setting of the load control unit at a randomized time with respect to other adjustments for other load control units from the one or more other load control units, where the instructions include a randomized time delay in the adjustment with respect to each other adjustment for the one or more other load control units.

In some implementations, the operations of the system further include receiving, from the sensor at the property, updated power grid frequency data, determining that the updated power grid frequency data satisfies a recovery frequency threshold value, and in response to determining that the updated power grid frequency data satisfies the recovery frequency threshold value, updating a setting of the load control unit at the property.

In some implementations, receiving the power grid frequency data indicating the locally measured power grid frequency at the property includes receiving a first locally measured power grid frequency at a first point in time and a second locally measured power grid frequency at a second, later point in time, and determining, from the power grid frequency data, the grid frequency event includes determining, using both of the first and second locally measured power grid frequencies, the grid frequency event.

In some implementations, the operations of the system further include in response to determining the grid frequency event, implementing a delay in adjusting the setting of the load control unit at the property.

In some implementations, adjusting the setting of the load control unit at the property includes only adjusting the setting of a first load control unit at the property and determining to not adjust a setting of one or more other load control units at the property. Only adjusting the setting of the first load control unit can include only adjusting the setting of a load control unit configured to control operations of a low priority load and determining to not adjust a setting of a different load control unit configured to control operations of a high priority load.

In some implementations, the operations of the system further include receiving, from sensors corresponding to a plurality of properties, power grid frequency data indicating respective locally measured power grid frequency at each of the plurality of properties, determining, from the respective locally measured power grid frequencies at each of the plurality of properties, a localized region including one or more properties of the plurality of properties experiencing the grid frequency event, generating a localized power grid event alert including information of the localized region, and providing the localized power grid event alert. This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. Because HVAC systems generally use 24 VAC to interface with thermostats, the thermostat having access to the grid frequency can be leveraged as part of a system that increases a likelihood of the stability of the grid, e.g., a grid fast frequency response (FFR) system. By more precisely measuring frequency in the time or frequency domains, compared to other systems, and subsequently deriving a rate-of-change-of-frequency (ROCOF), the thermostat can increase a likelihood of detecting and responding to a grid-level emergency event related to unexpected loss of generation or other grid emergency in a timeframe that would qualify as Primary Frequency Services. For example, the thermostat can perform a fast frequency response (FFR) by detecting and responding to a grid-level emergency event in a sub-two second range.

The thermostat can detect and respond to grid-level emergency events at the site of the event, e.g., at the property, rather than relying on cloud-based connectivity to a central system, which can reduce a time to respond as well as allow for rapid response even in the event that connectivity is unavailable.

The system described in this specification can reduce likelihood of a grid power outage. This can occur particularly in grids that increasingly rely on inverter-based resources (IBRs) and have an increased vulnerability to grid frequency fluctuations.

The thermostat can convey the grid emergency event to other systems and devices, e.g., in the property that don't measure frequency, e.g., smart switches. For instance, the thermostat can convey the grid emergency event to the back-end system so that a grid monitoring system can trigger an automated load control (ALC) event with an external command that is automatically generated once the grid emergency event is confirmed by a frequency-measuring thermostat in their same geographic area.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example operating environment for a grid supportive system.

FIG. 2 is a block diagram of an example load control unit for the grid supportive system.

FIG. 3 is a block diagram of an example embodiment of the grid supportive system.

FIG. 4A depicts example plots of an ALC response for a grid.

FIG. 4B depicts a plot of an example weighted profile.

FIG. 4C depicts example plots of another ALC response for a grid.

FIG. 5 is a flow diagram of a process for controlling power grid load at a property.

FIG. 6 is a diagram illustrating an example of a property monitoring system.

Like reference numbers and designations in the various drawings indicate like elements.

### DETAILED DESCRIPTION

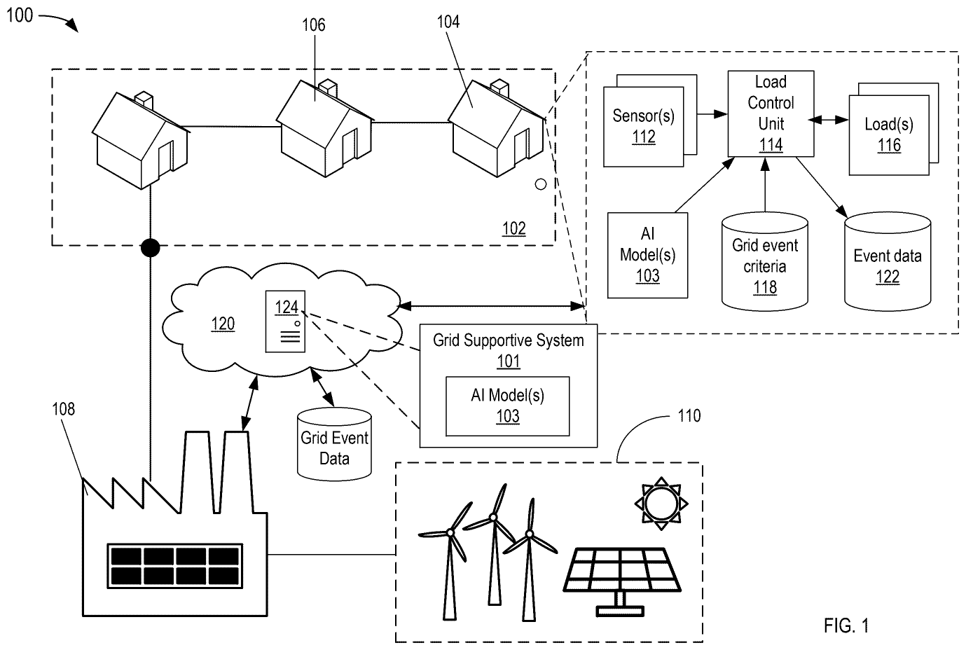

FIG. 1 is a block diagram of an example operating environment 100 for a grid supportive system 101. The grid supportive system 101 can be a component of a utility company system, can be in data communication with the utility company system, or a combination of both. In some examples, the grid supportive system 101 is separately implementable from a utility company system, where properties serviced by the utility company system may opt-in to the grid supportive system 101.

A grid region 102 includes properties connected to and configured to receive power from a power grid and includes multiple properties, e.g., properties 104, 106. The grid region 102 can be one of many grid regions each connected to the power grid, where each grid region 102 can have a separate electrical connection to the power grid such that a fault or loss of electrical connection to the power grid for a first grid region may not affect the electrical connection to a second grid region. A grid region can be, for example, a neighborhood, a residential development area, a commercial development area, a sub-division, or a combination thereof. Properties can include, for example, single-family homes, multi-family homes, commercial properties, a or another building type connected to the power grid. The grid region 102 receives power from energy generation sources, e.g., traditional power generators 108,inverter-based resources 110, or both. Energy generation sources can include traditional forms energy generation, e.g., thermal-based power generators 108 that use coal, natural gas, nuclear, or another fuel for thermal-based power generation, to generate steam to drive turbines. Power generators can employ automatic generation control (AGC) technologies to precisely measure frequency and automatically respond to detected changes in grid frequency and rate-of-change-of-frequency (ROCOF) by ramping up/down power generation to bring the grid frequency within a target range, e.g., within a target range of 60 Hz.

In some implementations, energy generation sources include inverter-based resources (IBRs) 110, for example, renewable energy sources such as wind and solar energy. IBRs 110 in general cannot be ramped up/down like traditional steam-based thermal power generators. A power grid which incorporates IBRs can implement automated load control (ALC) responses to maintain grid stability rather than, or in addition to, AGC technologies.

The property 104 includes at least one sensor 112 configured to measure a frequency of an input power to the property 104. For instance, the at least one sensor 112 is electrically connected to an alternating current (AC) power source that is at substantially a same frequency as the grid frequency provided to the property 104. The sensor 112 can be configured to provide an analog output proportional to the frequency of the input source (e.g., the grid 24 VAC power from the grid). The sensor is configured to measure the frequency of the AC power input, e.g., in the time domain, frequency domain, or both.

The sensor 112 can be a component of and/or in data communication with a local load control unit 114 of the property. The sensor can be, for example, a component (e.g., a line frequency sensor) of a thermostat. In some examples, a sensor can be a component and/or in data communication with an energy hub or another smart device electrically connected to the AC power source at the same frequency as the grid frequency.

Load control unit 114 is configured to control the operations of one or more loads 116 at the property. For example, a load control unit is a thermostat configured to control the operations of a heating, ventilation, and air conditioning (HVAC) unit at the property. Load control unit 114 can access stored grid event criteria 118 including instructions for how to detect and respond to grid frequency events. The grid supportive system 101 can provide, to each load control unit 114 in data communication with the grid supportive system 101 over a network 120, the grid event criteria 118 to implement to detect and respond to grid frequency events. The load control unit can store the grid event criteria 118 locally, e.g., in local memory, that is accessible even in the case where no connectivity to the network is available. In some implementations, some of the grid event criteria 118 can be predefined, e.g., by an administrator for the load control unit 114.

In some implementations, the load control unit 114 stores, e.g., in local memory, historical event data 122 including information related to past grid frequency events and associated event criteria triggered by the grid frequency events. The load control unit 114 can provide, to the grid supportive system 101, the event data 122 over the network 120, where the system 101 can store the event data 122, e.g., in a cloud-based system 124. In some implementations, load control unit 114 can provide real-time grid frequency event data 122 to the grid supportive system 101.

Although depicted as a grid supportive system 101 hosted on a system including one or more cloud-based servers 124, at least a portion of the grid supportive system 101 or local instantiations thereof can be stored locally at a property 104 of the grid region 102, e.g., at the load control unit 114. For example, a load control unit 114 can include a local instantiation of the grid supportive system 101 to perform at least some or all of the actions described with reference to the grid supportive system 101. The load control unit 114 can be configured to perform the actions without requiring real-time instructions from a cloud-based system instantiation of the grid supportive system 101, e.g., without network connectivity. In some examples, the load control unit 114 can be configured to detect and respond to grid frequency events without waiting for or requiring external validation or instructions on how to proceed.

In some implementations, the load control unit 114 receives, from the sensor 112, power grid frequency data including a local measurement of the power grid frequency at the property 104. The load control unit 114 determines, from the local measurement, the occurrence of a grid frequency event, e.g., a droop of the frequency or a ROCOF of the power provided to the property from the grid region 102. The load control unit can adjust a setting of the load control unit in response to the frequency event, e.g., adjust a set point to control operations of a load 116 in data communication with the load control unit 114.

In some implementations, the grid supportive system 101 receives grid frequency event data 122 from load control units corresponding to multiple properties of the grid. The grid supportive system can generate, from the grid event data, grid event criteria including an automated load control (ALC) response, update grid event criteria 118 responsive to the grid event data 122, or both.

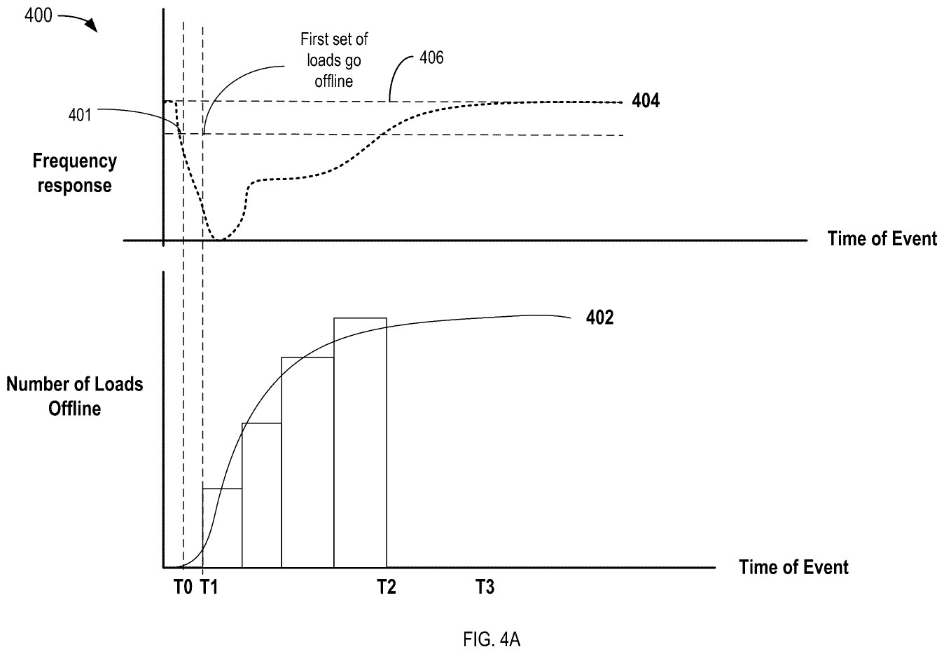

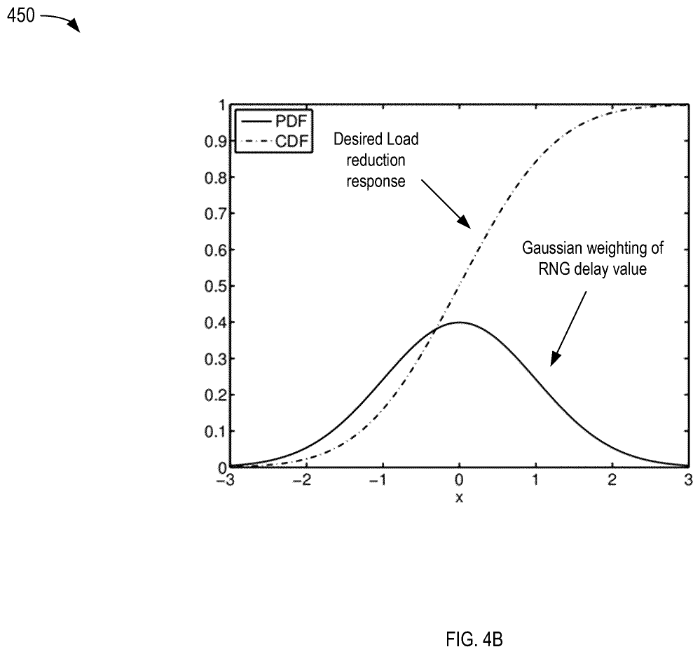

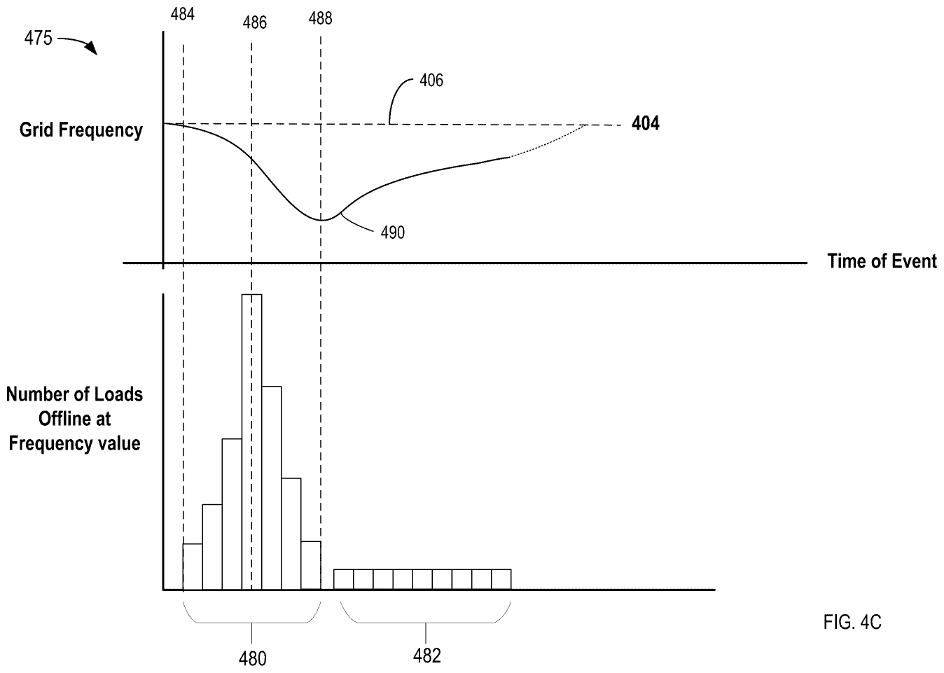

In some implementations, the ALC response can include a weighted response profile (e.g., as described with reference to FIGS. 4A, 4B below). The grid event criteria 118 includes a set of parameters for implementing the grid event response, e.g., parameters for detecting the occurrence of a grid frequency event, parameters for responding to the detected grid frequency event, or both. The grid event criteria 118 can include a prioritization for off-loading the loads at the property, which can be administrator-provided, provided by the grid supportive system 101, or both. The prioritization scheme can be used by the load control unit 114 to dictate which loads to cut based on grid demands, local usage of the loads, type of grid frequency event detected, a degree of the grid frequency event detected, or a combination of these.

The load control unit 114 can adjust settings for a subset of loads. In some implementations, adjusting the setting of the load control unit at the property includes only adjusting the settings of a proper subset of the loads at the property, e.g., adjusting settings of a first load control unit at the property and not adjusting a setting of one or more other load control units at the property. At times, only adjusting the setting of the first load control unit includes only adjusting the setting of a load control unit configured to control operations of a low priority load and not adjusting a setting of a different load control unit configured to control operations of a high priority load.

In some implementations, the system provides ALC response instructions to one or more energy generation systems for the grid. For example, to adjust output of the one or more energy generation systems. The system 101 can provide the ALC response instructions in real-time to energy generations systems, e.g., traditional power generators 108 and inverter-based resources 110, to adjust a power output at the one or more energy generation system 108, e.g., spin up/down generators, redirect power generation from a wind turbine or solar panel, or the like.

In some implementations, the system 101 provides the grid event criteria 118 including ALC response instructions to one or more properties in the grid, e.g., over the network. The grid event criteria 118 can be the same or different for each of the properties of the grid region 102. For example, a first property 104 can receive a different set of grid event criteria 118 than a second property 106, e.g., based on the loads present at each property, location of the property relative to the grid source, local batteries/back-up power sources available at the property, or a combination of these.

The grid supportive system 101 is an example of a system implemented as computer programs on one or more computers in one or more locations, in which the systems, components, and techniques described in this specification are implemented. The devices, e.g., load control units 114, can include personal computers, mobile communication devices, thermostats, smart switches, and other devices that can send and receive data over a network 120. The network, such as a local area network (“LAN”), wide area network (“WAN”), the Internet, or a combination thereof, connects the load control units 114, the cloud-based system 124, and the system 101. The grid supportive system 101 can use a single computer or multiple computers operating in conjunction with one another, including, for example, a set of remote computers deployed as a cloud computing service.

The grid supportive system 101 can include several different functional components, including a cloud-based system 124, and load control units 114. The cloud-based system, or load control units, or a combination of these, can include one or more data processing apparatuses, can be implemented in code, or a combination of both. For instance, each of the cloud-based system and load control units can include one or more data processors and instructions that cause the one or more data processors to perform the operations discussed herein.

The various functional components of the grid supportive system 101 can be installed on one or more computers as separate functional components or as different modules of a same functional component. For example, the grid supportive system 101 can be implemented as computer programs installed on one or more computers, e.g., load control units, in one or more locations that are coupled to each through a network. In cloud-based systems for example, these components can be implemented by individual computing nodes of a distributed computing system.

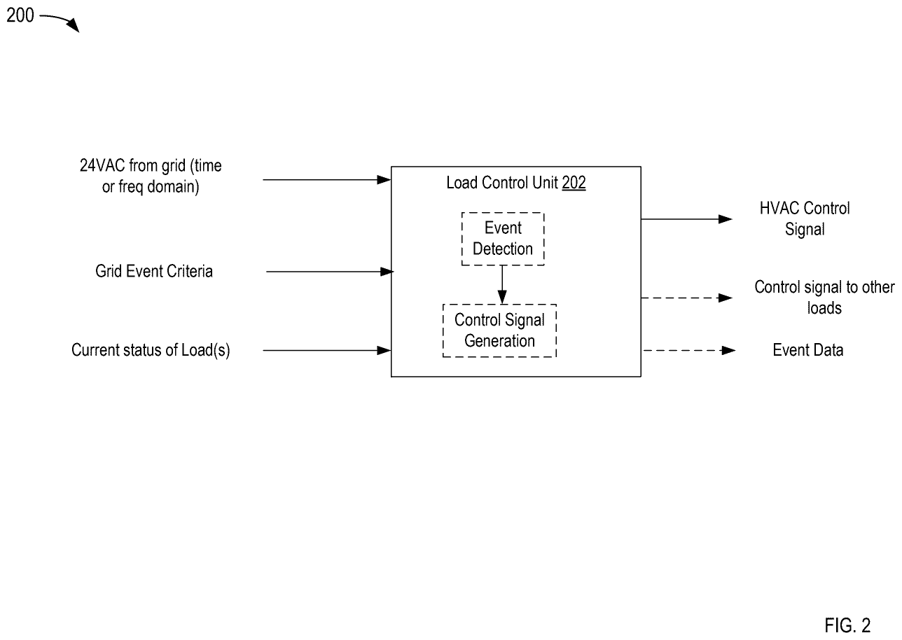

FIG. 2 is a block diagram 200 of an example load control unit for the grid supportive system. Load control unit 202 receives, as input, power from the grid, e.g., 24 VAC input. The load control unit includes a sensor, e.g., sensor 112, configured to measure (e.g., in time or frequency domain or both) the input power.

The load control unit 202 receives, as input, grid event criteria, e.g., grid event criteria 118. The load control unit 202 can store, in local memory, the grid event criteria received from the grid supportive system. A person, e.g., property owner, can update or provide additional grid event criteria, e.g., designate priorities for load dropping, designate high priority loads (medical supportive loads) that should be excluded from the grid response if possible.

The load control unit receives, as input, a current status of the one or more loads in data communication with the load control unit. For example, a load control unit is a thermostat where the thermostat receives a current status of an HVAC system in data communication with the thermostat, e.g., is the HVAC on/off, a current set point of the HVAC system, or the like.

The load control unit detects, from the input(s), the occurrence of a grid frequency event, and triggers, in response to the detected grid frequency event, a response, e.g., a grid event alert. Generating a response can include generating, by the load control unit 202, control signals in response to the detected grid frequency event, when the response is based part on the current state of the loads and the grid event criteria, e.g., dictating how to respond to the type of grid event.

The load control unit 202 provides, as output, the load control signals to a load, e.g., load 116. For example, the load control unit 202 is a thermostat that provides load control signals, e.g., as a type of instruction, to an HVAC system to adjust a set point or operating mode of the HVAC system, e.g., to shut off the HVAC system.

In some implementations, the load control unit 202 provides, as output, a grid event alert to one or more other loads. The load control unit can output an alert, responsive to the grid frequency event, to one or more other loads in data communication with the load control unit 202, e.g., within a threshold vicinity of the load control unit. For example, the load control unit can provide load control signals to other loads in data communication with the load control unit, e.g., smart switches, other appliances, or the like, in a threshold vicinity of the load control unit to trigger ALC response in the one or more other loads. A threshold vicinity can be, for example, other loads located at the same property or within a radius of the affected property, e.g., all the neighboring properties, properties on the same sub-grid, or both.

In some implementations, the load control unit 202 provides, as output, event data for the detected grid event. For example, the load control unit provides event data 122 to the grid supportive system 101 through the network 120. The event data can include actions taken by the load control unit 202, measured grid frequency data, grid event criteria used to detect and respond to the grid event, load(s) status before, during, and after the grid event, or a combination of two or more of these. The system can receive event data from two or more load control units for respective properties located in a same grid, e.g., grid region 102, and perform analysis on the received data to characterize the grid frequency event.

In some implementations, the system can receive, from load control units at respective properties in a grid, power grid frequency data collected by respective sensors of the load control units indicating respective locally measured power grid frequency at each of the respective properties. The locally measured power grid frequency can correspond to a line voltage from the grid to the respective property. The system can determine, from the respective locally measured power grid frequencies at each of the properties, a localized region including one or more of the properties experiencing the grid frequency event. At times, the system can determine that fewer than all the properties within a grid experienced the grid event. This can be indicative of a failing or compromised portion of the grid and can indicate a location where repairs/replacement is indicated. The system can generate a localized grid event alert which includes information about the localized region and provide it to interested parties. For example, the localized event alert can be provided to utility repair personnel to identify the area of the grid requiring maintenance/repair. The localized event alert can be provided to utility providers to gain insight on usage of the grid, areas where the grid is overburdened, or a combination of these.

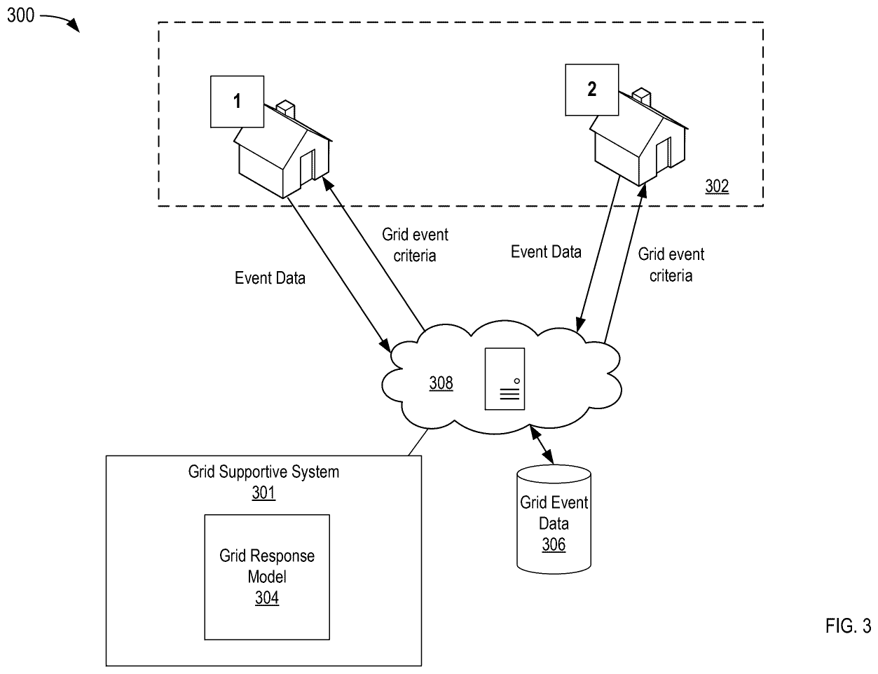

In some implementations, the system can generate a grid response model for the grid, one or more ALC responses for implementation by the properties of the grid, or a combination of both. FIG. 3 is a block diagram 300 of an example embodiment of the grid supportive system. As depicted, property 1 and property 2 located and connected to grid 302 each are in data communication with the grid supportive system 301 through network 308. The grid supportive system can provide, to each of the properties 1 and 2, grid event criteria which includes ALC response information dictating how the load control unit(s) at the properties should detect and respond to grid events. At times, the grid supportive system can provide different grid event criteria to the different properties in a grid such that at least one of the properties can implement a different ALC response than one other of the properties of the grid.

In some implementations, the grid supportive system can adjust the grid event criteria using historical data provided by the various load control units. The system can analyze the grid event data collected from the multiple load control units at the properties of the grid, the frequency response of the grid before, during, and after the grid event, and the grid event criteria to assess the ALC responses implemented and determine whether to adjust the conditions under which the occurrence of the grid event is detected, the conditions for implementing the response need to be adjusted, or both. For example, the system can determine that a threshold quantity, e.g., too many, loads went offline too quickly, causing an instability in the overall frequency of the grid, and implement an updated weighted profile such that fewer loads are instructed to go offline initially. An example of a profile is depicted in FIG. 4B below.

In some implementations, the grid supportive system 301 receives grid event data 306 from the properties of the grid 302 and generates a grid response model 304, e.g., an ALC response model. The grid event data can include the conditions under which the one or more load control units of the respective properties detected a grid event, the response taken by the one or more load control units, the recovery of the grid in response, or a combination of these. The model 304 can represent the cumulative ALC responses of the various properties of the grid in view of the grid event. The model can be trained on the historical grid event data to predict how the grid will respond to a given ALC response including the off-loading of loads from the properties according to a response profile. For example, system 301 can use historical grid event data collected for prior grid events and corresponding responses to refine the model 304, e.g., to avoid over-shedding or under-shedding of the loads. In this way, the model 304 can act as a feedback mechanism to avoid destabilizing the grid, reducing a cost of grid management, or both. In some examples, the model 304 can be used to predict how to incorporate new loads to the power grid, e.g., when new properties are added to the power grid, existing properties update their overall load on the power grid, or both.

In some implementations, model 304 can incorporate historical weather data to generate predictions of how to stabilize the grid in response to a detected grid event. For example, the model 304 can include grid event data for severe inclement weather and how the ALC responses by the load control units of the power grid affected the recovery of the power grid from the grid event.

In some implementations, model 304 can, based on a target grid stability outcome, generate respective sets of grid event criteria to be used by each of the load control units to enforce an ALC response. For example, the model 304 can generate a weighted response profile for the set of properties included in the grid to optimize a recovery of the grid in response to a detected grid event. The system 301 can provide the respective grid event criteria to each load control unit of the properties in the grid 302.

A set of grid event criteria used by the load control unit can include conditions, thresholds, or both, met by the frequency or ROCOF measured by the sensor of the load control unit. The load control unit can use the set of grid event criteria to dictate how to detect, define, and respond to a grid frequency event, e.g., according to various different metrics based on a type of load operated by the load control unit. At times, the set of grid event criteria can include custom profiles for different load control units, or for different loads operatively coupled to a load control unit. The grid supportive system can provide a load reduction profile implementable by a specific grid region including one or more properties, where the load reduction profile can be customized based on various characteristics of the grid region.

In some implementations, a grid event criteria includes a frequency threshold value, e.g., a frequency at which the load control unit determines the occurrence of a grid event and triggers an ALC response. The grid event criteria can include a minimum frequency threshold value, a maximum frequency threshold value, or a combination of both. In some examples, a system, e.g., the system or the load control unit, can determine that a locally measured power grid frequency does not satisfy the frequency threshold value included in the grid event criteria and trigger the ALC response. A frequency threshold value can be, for example, a measured deviation of 0.05 Hz, 0.1 Hz, 0.2 Hz, 0.5 Hz, 0.75 Hz or more from a nominal value, e.g., from 60 Hz.

In some implementations, a grid event criteria includes a ROCOF threshold value, e.g., a rate of change of a measured frequency that will cause the load control unit to determine the occurrence of a grid event and trigger an ALC response. In some examples, the system can determine that a ROCOF does not meet a minimum ROCOF and trigger an ALC response. A minimum ROCOF can be a negative frequency rate of change, a positive frequency rate of change, an absolute value, or a combination of these. A minimum ROCOF threshold value can be, for example, a measured ROCOF of −0.950 Hz/sec.

In some implementations, a grid event criteria includes a recovery frequency hysteresis, e.g., a frequency difference between a minimum or maximum frequency threshold and a recovery frequency at which point the determined grid frequency event is cleared. A recovery frequency can be a frequency at which point the set point offset is cleared. For example, a sensor of a load control unit can measure a first frequency of 60 Hz at time TO and subsequently measure a second frequency at a first threshold value of 59.000 Hz at a time T1. The load control unit will determine an occurrence of a grid event and provide control instructions to a load to alter a setpoint of the load (e.g., turn the load off). The load control unit will not clear the grid event until the sensor measures a third frequency at a time T2 meeting at least a threshold recovery frequency, e.g., 59.500 Hz, for at least a period of time to prevent frequent fluctuations of power to the load.

In some implementations, the grid event criteria includes a staggered recovery phase, in which the load control unit provides updated control signal to alter the operation of loads of different types (e.g., different power requirements, different importance levels, or both.) at staggered times. For example, the load control unit provides updated control signals to bring loads having a high importance rating back online more quickly than loads having a low importance rating.

In some implementations, the grid event criteria includes a recovery ROCOF hysteresis, e.g., a rate of change of frequency difference between a minimum and maximum ROCOF threshold and a recovery ROCOF at which point the determined grid frequency event is cleared. In some examples, the system detects a recovery ROCOF and clears the set point offset. For example, a sensor of a load control unit can measure a first ROCOF of −0.010 Hz/sec at time T0 and subsequently measure a second ROCOF at a first threshold value of −0.085 Hz/sec at a time T1. The load control unit will determine an occurrence of a grid event and provide control instructions to a load to alter a setpoint of the load (e.g., turn the load off). The load control unit might not clear the grid event until the sensor measures a third ROCOF at a time T2 meeting at least a threshold recovery frequency, e.g., 0.050 Hz/sec, for at least a period of time to prevent frequent fluctuations of power to the load.

In some implementations, the grid event criteria includes a frequency threshold delay, e.g., a duration between measuring by a sensor a frequency threshold crossing and triggering, by the load control unit, an adjustment in a setting of the load control unit at the property. For example, a delay can be, e.g., 2 seconds, 3 second, 4 seconds, 5 or more seconds, for which the load control unit implements the delay before generating, providing, or both, control signals to adjust the operation of or a setpoint of a load in data communication with the load control unit. In some implementations, the grid supportive system can implement an arbitrary frequency response profile distributed over multiple properties of the grid using a randomization of the frequency threshold delay. In some examples, each load control unit of multiple load control units corresponding to respective properties can generate a delay time in response to a grid event using a weighted random number generator (RNG) profile. In this way, the load control units executing a same weight profile can operate by each choosing a randomized number weighted to a target common profile, but without requiring instructions to proceed for each detected grid event. A weighted profile can randomize the implemented delay across the multiple properties. The randomized implementation can cumulatively generate a target timing of the offloading of the loads at the properties.

FIG. 4A depicts example plots of an ALC response for a grid. Plot 400 depicts a frequency response curve of the grid frequency from a point TO when a frequency event is detected (by the load control units of the grid), for which the threshold crossing point 401 is a value relative to the nominal operating frequency of the grid. The threshold crossing point 401 can be any appropriate type of value such as a fractional value or an absolute value relative to the nominal operating frequency.

In some implementations, the system can implement a time-based ALC response, for example, as depicted in FIG. 4A. The system can implement a delay before implementing an ALC response by waiting for two or more measurements prior to triggering a response to a grid event. For example, the load control unit can receive a first locally measured power grid frequency by a sensor of the load control unit at a first point in time and a second locally measured power grid frequency by the sensor of the load control unit at a second, later point in time. The load control unit can determine the occurrence of the grid event using both the first and second locally measured power grid frequencies. This can reduce a likelihood of changes to settings given minor fluctuations for which the load control unit need not make changes, e.g., reduce resource usage, improve an accuracy of the system, or both.

In some implementations, the load control unit can implement a delay prior to adjusting the setting of a load in data communication with the load control unit. For example, as depicted in FIG. 4A, a delay until time T1 (e.g., to avoid reacting to transient fluctuations) is implemented. At T1, line 402 depicts a gradual offloading of the loads where the load control units initiate a staggered offloading of the loads until a time T2 where all loads are offline. Line 404 tracks the frequency response as the loads go offline, where the frequency response recovers towards a nominal value 406 as the coordinated offloading of loads go offline until a time T3 at which the system (e.g., the load control units responding to the grid event) determines that the frequency event is concluded. Time T3 can coincide with a second threshold crossing point that may be the same or a different value than the first threshold crossing point.

In some implementations, the grid supportive system can implement a weighted profile to weight the responses of the load control units of the grid to a detected grid frequency event. For example, a weighted profile can specify a target number of loads, target amount of load, or a combination of both, off-loaded in each time step to stagger the off-loading of loads in the grid region. A weighted profile can be, for example, a Gaussian, linear, step function, or another appropriate type of weighting scheme. A set of load control units at respective properties in a grid region can operate as a collective to implement the weighted profile. Each of the set of load control units can select, e.g., using an RNG, a random number that is weighted to the target profile to calculate the time delay to execute before off-loading the load(s) in data communication with the load control unit. The set of load control units can execute, as a collective, the weighted profile without requiring the grid supportive system to provision each time delay assigned to each load control unit in response to a grid frequency event.

In some implementations, each of the load control units can execute the same weighted RNG profile using a respective delay value calculated for each instance of a detected grid frequency event, yielding the targeted time-distributed load reduction response across the multiple properties in the designated region of the grid. In some instances, each load control unit will act according to a unique, randomized set of parameters, e.g., a randomized time delay after detection of the grid frequency event before initiating updates to set points of one or more loads. In this way, the group of load control units from the designated region of the grid execute a collective weighted profile while individually acting according to a different, randomized set of parameters.

In some implementations, at least one of the one or more other load control units are located a different property within the threshold vicinity of the property. The system can implement, for each of the one or more other load control units in the threshold vicinity of the sensor at the property, a respective adjustment of a setting of the load control unit. Implementing the adjustment can include a randomized time delay in the adjustment with respect to each other adjustment for the one or more other load control units.

In some implementations, the implemented weighted profile can be adjusted to meet requirements of the power grid. For example, a weighted profile can reflect a ratio of IBRs vs traditional power generators. The system can select a weighted profile based in order to provide synthetic inertia, e.g., simulated inertial response, in response to a grid event. The synthetic inertia can mimic a power generator coming online through staggered re-loading by loads of the grid.

In some implementations, the system can select a weighted profile to include a negative load profile, e.g., to cause the grid can receive power back to the grid from one or more properties connected to the grid. For example, batteries, solar generators, or another form of available power generation or power storage, at a property can provide power back to the grid via the inverter when a threshold critical need requirement is triggered by the grid event.

FIG. 4B depicts a plot of an example weighted profile. The weighted profile can include parameters, e.g., a total duration of response, a time delay before initiating a first set of off-loading of loads, a number of loads to off-load in each time step, an interval of each time step, time delay after event has been resolved before ending the load shed action (e.g. change set point back or tern load switch back on), or a combination of these.

As depicted in FIG. 4B, a grid supportive system can implement a Gaussian response to a grid frequency event, e.g., a rapid drop in grid frequency, by providing, to the load control units in a designated region of the grid, a Gaussian profile. The load control units use a number within the range of time. The number for each load control unit can be randomly assigned, e.g., using an RNG. A time range can be, for example, a six second range, where all the load control units will off-load their respective loads by the end of the range of time. According to the weighted profile, a larger fraction of the load control units have a number in the middle of the range of time, and fewer with numbers at the edges of the range of time. All load control units execute their respective set point changes by the end of the range of time. The range of time implemented by the weighted profile can be set by the grid supportive system, e.g., a duration is set or altered in response to observed impact of the offloading of loads from the grid in response to a grid event in the grid event data.

In some implementations, the grid supportive system can provide a “synthetic inertia” to the power grid, e.g., a power grid including IBR generators, in response to a grid frequency event. In instances where a power grid includes non-IBR generators, e.g., thermal-based generators, the torque experienced by a collective spinning of non-IBR generators connected to the power grid during a grid event provides an inertia to the frequency response of the power grid and that can be proportional to the ROCOF of the power grid. For example, if the ROCOF is a negative value, the torque force on the non-IBR generators is reactive against a direction in which the generators are spinning. In a power grid including IBR generators, the grid supportive system can shape a collective load-shed curve of load-managed devices controlled by respective load control units and connected to the power grid to proportionally counteract the ROCOF in real time. The shape of the collective load-shed of the connected load-managed devices can provide a constant synthetic inertial torque that mimics the inertial torque associated with the spinning of non-IBR generators.

In some implementations, the grid supportive system can implement a frequency-triggered grid event response by assigning, to each load control unit, a frequency threshold, e.g., a frequency trigger rather than a time-delay. FIG. 4C depicts example plots of another ALC response for a grid.

FIG. 4C depicts an example plot 475 of a frequency response 404 of a power grid during a grid frequency event and the corresponding frequency-triggered load shedding of the load control units connected to the power grid. As depicted in FIG. 4C, respective sets of load control units 480 are each programmed with frequency thresholds between a target frequency 406 and a minimum expected grid event frequency 488. A set of load control units is programmed with a set of frequency thresholds that are distributed linearly between a target frequency 404, e.g., 50 Hz or 60 Hz, and a minimum expected grid event frequency 488, e.g., based on historical grid frequency events for the set of load control units, determined from regulatory standards or utility based on AGC/ALC requirements. For example, frequency thresholds for triggering load shedding 484, 486, 488 are used by respective sets of load control units to trigger the load control units to shed respective connected loads. As the frequency of the grid drops during a grid frequency event, the load control units will shed the loads according to the assigned frequency threshold values such that the load-shed is proportional to the ROCOF, thereby providing the synthetic inertia, e.g., approximately, proportional to the ROCOF.

In some implementations, the grid supportive system implements additional alternative frequency, ROCOF-triggered load-shed profiles, or both, for the set of load control units such that the torque force responsive to the grid frequency event is stronger when the grid frequency is farther from a target frequency. For example, the grid supportive system can deploy a load-shed profile to provide a torque force, e.g., approximately, proportional to the gap between the target grid frequency and the actual frequency.

A frequency-responsive grid frequency event response can be independent of a real-time communication between the set of frequency-responsive load control units. At times, grid supportive system can provide parameter updates to the load control units, e.g., updated traits based on collected/learned responses of the load control units, updates to the power grid AGC/ALC implementation strategy.

In some implementations, the grid supportive system can designate, for a subset of the load control units 482, a delay until the power grid reaches a local minimum frequency 488, e.g., a nadir frequency, before initiating the triggering the load-shed for the subset of load control units 482. This can increase a likelihood that there are load-shed reserves available to assist in the recovered of the grid emergency event when the ROCOF is a positive value but the grid frequency is still below the target frequency. For example, the grid frequency event can occur on a rising-edge 490. The grid supportive system can program the load control units to have both a falling edge threshold as well as a rising edge threshold, such that if the falling edge threshold is not met, the load control unit might still participate in the ALC event response on the rising edge threshold.

In some implementations, the grid supportive system analyzes a collection of grid emergency events such that the devices predict a grid failure type. In some instances, the grid supportive system implements a convolutional neural network (CNN) or other structure of machine-learning or AI modeling to predict the expected profile of the grid emergency event in real time, based on various frequency and ROCOF markers identified by the AI model 103, and then responds accordingly. The grid supportive system can generate and train the AI model 103 using one or more cloud-based computers, and deploy the trained AI model to the load control units. For example, the system can provide a trained AI model 103 to a set of load control units that can analyze the grid event frequency profile in real-time and predict various attributes of the grid event profile, e.g., before the attributes occur. Some examples of the attributes can include the expected nadir frequency, the minimum or maximum ROCOF expected, the duration of the grid event, the likelihood and/or timing of other AGC/ALC responses being triggered, likelihood of blackouts occurring, or a combination of these.

In some implementations, the grid supportive system can provide multiple, different load profiles to the load control units such that different load profiles can be triggered at the load control units based on the AI predictive model. For example, the AI predictive model loaded on a load control unit may analyze the first 500 milliseconds (ms) of a grid event frequency profile and determine with 95% confidence that this load event will result in a nadir frequency of >59.550 Hz. The AI predictive model can determine, e.g., with the same confidence, that the optimal load-shed profile to minimize the negative impacts of the event, e.g., blackouts, damaged equipment, etc., is to deploy a load shed profile linearly correlated to the frequency, starting when the falling edge of the frequency drops below 59.750 Hz and until the frequency reaches 59.450. A ny load control units that are not triggered on the falling edge of the frequency curve can be deployed on the rising edge distributed evenly over the following 10 seconds. Upon making this determination, the AI predictive model can provide output that identifies the optimal load-shed profile. The load control unit 114 can use the optimal load-shed profile to generate one or more control signals to adjust a setting of a load that is within a threshold distance of a corresponding property.

In some implementations, a grid response profile can be chosen by the load control unit from a pre-designated set of profiles. Since at least a subset, e.g., all, of the load control units in single cohort can run the same AI model, use of the pre-designated set of profiles can increase a likelihood that all or nearly all of the load control units will converge on the same ideal load-shed profile. Convergence on the same ideal load-shed profile can enable each of the respective load control units to use the same or substantially similar weighted random-number generator to determine the parameters controlling the load-shed trigger for that load control unit, e.g., frequency threshold, RoCoF threshold, time delay, rising edge/falling edge, etc. For a large enough cohort of load control units, the AI-optimized load-shed profile applied using a weighted random number generator can align with the target profile, e.g., even though the profile was individually determined on each load-management device separately, without communicating with any other device.

In some implementations, the grid event criteria includes a minimum or maximum ALC event duration, e.g., a threshold time that the ALC response is enforced regardless of whether frequency or ROCOF recovery conditions are met. For example, a load control unit can implement a minimum or maximum amount of time before providing updated control signals to a load to revert to normal or recovery mode operations.

In some implementations, the grid event criteria includes periodic or continuous sampling of the power grid frequency data by the sensor of the load control unit. The load control unit can receive the updated power grid frequency data and determine whether the updated power grid frequency data satisfies a recovery frequency threshold value. In response to determining that the updated power grid frequency data satisfies the threshold value, the load control unit updates a setting of the load control unit at the property. The updated setting can be, for example, a prior value, a second value, a recovery value, an intermediate value, or the like. In response to determining that the updated power grid frequency data does not satisfy the threshold value, the load control unit can continue to enforce the ALC response,.e.g., the previously provided set point change, operational mode, or both. The load control unit can continue to sample the power grid frequency data to monitor whether the recovery frequency threshold value is satisfied at a later point in time. The load control unit can continue the sample of power grid frequency data until the updated power grid frequency data satisfies the recovery frequency threshold value or a threshold ALC event duration is met, or a combination of both.

In some implementations, the grid event criteria includes different ALC event types, e.g., depending on a type of load connected to the load control unit, a type of load control unit, or a combination of both. Each of the different ALC event types can dictate a separate set of grid event criteria for detecting an occurrence of a grid event, responding to the grid event, or a combination of both. For example, a first type of ALC event is a thermostat set point offset provided by the thermostat to an HVAC system. This can include a maximum number of degrees that the set point can be adjusted during an ALC event. In some examples, a second type of ALC event is a smart switch mode change to alter a set point of one or more appliances on a corresponding dedicated outlet, e.g., large appliances having more than about 500 W of power draw. In some examples, a third type of ALC event is a solar inverter disconnect, where a solar panel inverter can provide power back through a metering device to the grid to supply power to the grid rather than to the property.

In some examples, a load control unit can implement different grid event criteria based in part on a current status of the load(s) in data communication with the load control unit. For example, a load control unit can adjust a maximum number of degrees that the set point can be adjusted during an ALC event in severe weather, e.g., extreme heat or cold.

In some implementations, a grid event criteria includes a thermostat lock during an ALC event where the thermostat locks control, e.g., manual override, of a thermostat during an ALC event.

The above examples allow a load control unit to react to a detected grid frequency event in a, e.g., more, predictable manner. In some implementations, the grid supportive system can provide grid event criteria to multiple load control units corresponding to properties in a region of a grid, for which the grid event criteria for the multiple load control units can be varied such that the response to a grid frequency event can be shaped based on the needs of the operators.

In some implementations, the grid supportive system adjusts the grid event criteria based on a ratio of IBRs on the grid, a number of properties connected to the grid, types of properties on the grid, average demand of the grid, weather conditions, or a combination of two or more of these.

In some implementations, the load control unit can use a combination of some or all of the grid event criteria of the set of grid event criteria to perform different actions. For example, in response to a high measured ROCOF, the load control unit can enact a rapid response to the grid frequency event rather than using one or more other thresholds or conditions of the event criteria, e.g., rather than waiting for a threshold minimum frequency criteria to be met.

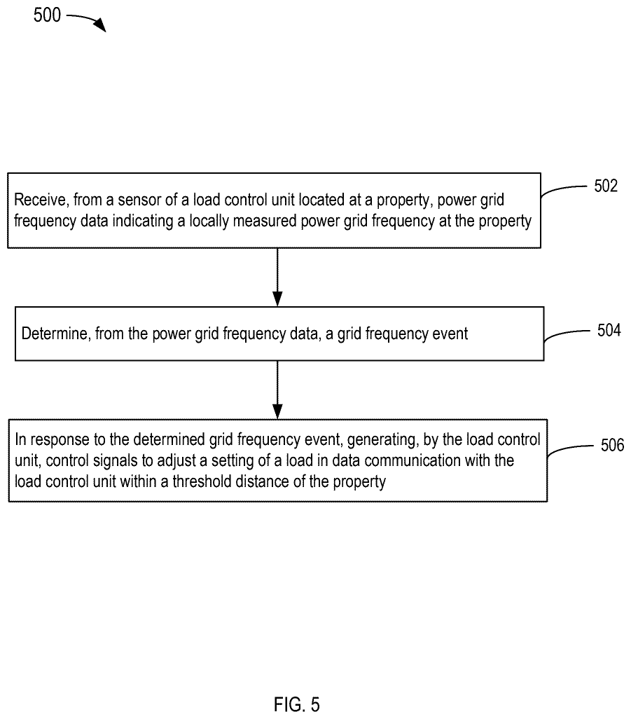

FIG. 5 is a flow diagram of a process 500 for controlling power grid load at a property. For example, the process 500 can be used by the grid supportive system 101, the load control unit 114, or a combination of both, from the environment 100.

The system receives 502, from a sensor of a load control unit located at a property, power grid frequency data indicating a locally measured power grid frequency at the property. The sensor of the load control unit, e.g., a sensor of a thermostat at the property, can receive as input the line voltage from the power grid. The sensor can measure periodically or continuously the frequency of the line voltage, e.g., in the time domain or frequency domain.

The system determines 504, from the power grid frequency data, a grid frequency event. The load control unit can store grid event criteria locally, e.g., on device, to determine whether a measurement or a set of measurements of the frequency of the line voltage is indicative of a grid frequency event.

In response to the determined grid frequency event, the load control unit generates 506 control signals to adjust a setting of a load in data communication with the load control unit within a threshold distance of the property. The load control unit can generate and provide control signals to adjust a setpoint, an operational mode, or both, of a load in data communication with the load control unit. For example, a thermostat can update a temperature setpoint or toggle the HVAC system in data communication with the thermostat to an “off” operation mode.

In some implementations, the process 500 can include additional operations, fewer operations, or some of the operations can be divided into multiple operations. In some examples, some or all of the process 500 can be performed locally at the load control unit at the property and without requiring network connectivity to perform the operations. For example, the system can determine the grid frequency event over multiple time stamps and using multiple measurements made of the local frequency input to the sensor and from the power grid over the multiple time stamps. In some examples, the system can adjust the settings of the load control unit at the property two or more times, e.g., once in response to detecting the grid event and a second, later time in response to determining the end of the grid event.

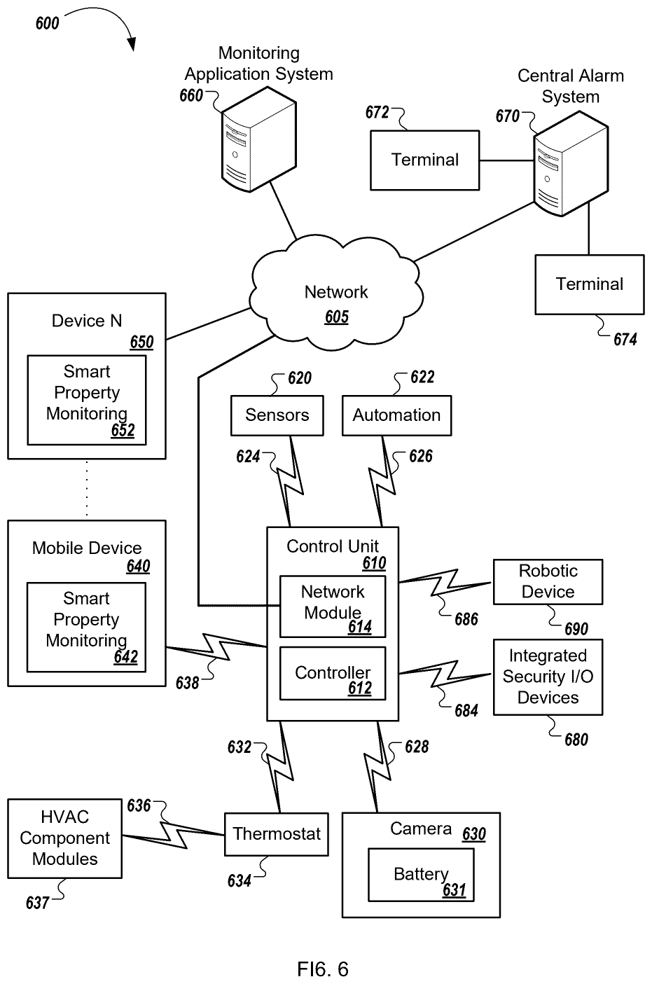

FIG. 6 is a diagram illustrating an example of an environment 600, e.g., for monitoring a property. The property can be any appropriate type of property, such as a home, a business, or a combination of both. The environment 600 includes a network 605, a control unit 610, one or more devices 640 and 650, a monitoring system 660, a central alarm system 670, or a combination of two or more of these. In some examples, the network 605 facilitates communications between two or more of the control unit 610, the one or more devices 640 and 650, the monitoring system 660, and the central alarm system 670.

The network 605 is configured to enable exchange of electronic communications between devices connected to the network 605. For example, the network 605 can be configured to enable exchange of electronic communications between the control unit 610, the one or more devices 640 and 650, the monitoring system 660, and the central alarm system 670. The network 605 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 605 can include multiple networks or subnetworks, each of which can include, for example, a wired or wireless data pathway. The network 605 can include a circuit-switched network, a packet-switched data network, or any other network able to carry electronic communications (e.g., data or voice communications). For example, the network 605 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 605 can include one or more networks that include wireless data channels and wireless voice channels. The network 605 can be a broadband network.

The control unit 610 includes a controller 612 and a network module 614. The controller 612 is configured to control a control unit monitoring system, e.g., a control unit system, that includes the control unit 610. In some examples, the controller 612 can include one or more processors or other control circuitry configured to execute instructions of a program that controls operation of a control unit system. In these examples, the controller 612 can be configured to receive input from sensors, or other devices included in the control unit system and control operations of devices at the property, e.g., speakers, displays, lights, doors, other appropriate devices, or a combination of these. For example, the controller 612 can be configured to control operation of the network module 614 included in the control unit 610.

The network module 614 is a communication device configured to exchange communications over the network 605. The network module 614 can be a wireless communication module configured to exchange wireless, wired, or a combination of both, communications over the network 605. For example, the network module 614 can be a wireless communication device configured to exchange communications over a wireless data channel and a wireless voice channel. In some examples, the network module 614 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 614 can be a wired communication module configured to exchange communications over the network 605 using a wired connection. For instance, the network module 614 can be a modem, a network interface card, or another type of network interface device. The network module 614 can be an Ethernet network card configured to enable the control unit 610 to communicate over a local area network, the Internet, or a combination of both. The network module 614 can be a voice band modem configured to enable the alarm panel to communicate over the telephone lines of Plain Old Telephone Systems (“POTS”).

The control unit system that includes the control unit 610 can include one or more sensors 620. For example, the environment 600 can include multiple sensors 620. The sensors 620 can include a lock sensor, a contact sensor, a motion sensor, a camera (e.g., a camera 630), a flow meter, any other type of sensor included in a control unit system, or a combination of two or more of these. The sensors 620 can include an environmental sensor, such as a temperature sensor, a water sensor, a rain sensor, a wind sensor, a light sensor, a smoke detector, a carbon monoxide detector, or an air quality sensor, to name a few additional examples. The sensors 620 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 620 can include a radio-frequency identification (“RFID”) sensor that identifies a particular article that includes a pre-assigned RFID tag.

The control unit 610 can communicate with a module 622 and a camera 630 to perform monitoring. The module 622 is connected to one or more devices that enable property automation, e.g., home or business automation. For instance, the module 622 can connect to, and be configured to control operation of, one or more lighting systems. The module 622 can connect to, and be configured to control operation of, one or more electronic locks, e.g., control Z-Wave locks using wireless communications in the Z-Wave protocol. In some examples, the module 622 can connect to, and be configured to control operation of, one or more appliances. The module 622 can include multiple sub-modules that are each specific to a type of device being controlled in an automated manner. The module 622 can control the one or more devices using commands received from the control unit 610. For instance, the module 622 can receive a command from the control unit 610, which command was sent using data captured by the camera 630 that depicts an area. In response, the module 622 can cause a lighting system to illuminate an area to provide better lighting in the area, and a higher likelihood that the camera 630 can capture a subsequent image of the area that depicts more accurate data of the area.

The camera 630 can be an image camera or other type of optical sensing device configured to capture one or more images. For instance, the camera 630 can be configured to capture images of an area within a property monitored by the control unit 610. The camera 630 can be configured to capture single, static images of the area; video of the area, e.g., a sequence of images; or a combination of both. The camera 630 can be controlled using commands received from the control unit 610 or another device in the property monitoring system, e.g., a device 650.

The camera 630 can be triggered using any appropriate techniques, can capture images continuously, or a combination of both. For instance, a Passive Infra-Red (“PIR”) motion sensor can be built into the camera 630 and used to trigger the camera 630 to capture one or more images when motion is detected. The camera 630 can include a microwave motion sensor built into the camera which is used to trigger the camera 630 to capture one or more images when motion is detected. The camera 630 can have a “normally open” or “normally closed” digital input that can trigger capture of one or more images when external sensors detect motion or other events. The external sensors can include another sensor from the sensors 620, PIR, or door or window sensors, to name a few examples. In some implementations, the camera 630 receives a command to capture an image, e.g., when external devices detect motion or another potential alarm event or in response to a request from a device. The camera 630 can receive the command from the controller 612, directly from one of the sensors 620, or a combination of both.

In some examples, the camera 630 triggers integrated or external illuminators to improve image quality when the scene is dark. Some examples of illuminators can include Infra-Red, Z-wave controlled “white” lights, lights controlled by the module 622, or a combination of these. An integrated or separate light sensor can be used to determine if illumination is desired and can result in increased image quality.

The camera 630 can be programmed with any combination of time schedule, day schedule, system “arming state”, other variables, or a combination of these, to determine whether images should be captured when one or more triggers occur. The camera 630 can enter a low-power mode when not capturing images. In this case, the camera 630 can wake periodically to check for inbound messages from the controller 612 or another device. The camera 630 can be powered by internal, replaceable batteries, e.g., if located remotely from the control unit 610. The camera 630 can employ a small solar cell to recharge the battery when light is available. The camera 630 can be powered by a wired power supply, e.g., the controller's 612 power supply if the camera 630 is co-located with the controller 612.

In some implementations, the camera 630 communicates directly with the monitoring system 660 over the network 605. In these implementations, image data captured by the camera 630 need not pass through the control unit 610. The camera 630 can receive commands related to operation from the monitoring system 660, provide images to the monitoring system 660, or a combination of both.

The environment 600 can include one or more thermostats 634, e.g., to perform dynamic environmental control at the property. The thermostat 634 is configured to monitor temperature of the property, energy consumption of a heating, ventilation, and air conditioning (“HVAC”) system associated with the thermostat 634, or both. In some examples, the thermostat 634 is configured to provide control of environmental (e.g., temperature) settings. In some implementations, the thermostat 634 can additionally or alternatively receive data relating to activity at a property; environmental data at a property, e.g., at various locations indoors or outdoors or both at the property; or a combination of both. The thermostat 634 can measure or estimate energy consumption of the HVAC system associated with the thermostat. The thermostat 634 can estimate energy consumption, for example, using data that indicates usage of one or more components of the HVAC system associated with the thermostat 634. The thermostat 634 can communicate various data, e.g., temperature, energy, or both, with the control unit 610. In some examples, the thermostat 634 can control the environment, e.g., temperature, settings in response to commands received from the control unit 610.

In some implementations, the thermostat 634 is a dynamically programmable thermostat and can be integrated with the control unit 610. For example, the dynamically programmable thermostat 634 can include the control unit 610, e.g., as an internal component to the dynamically programmable thermostat 634. In some examples, the control unit 610 can be a gateway device that communicates with the dynamically programmable thermostat 634. In some implementations, the thermostat 634 is controlled via one or more modules 622.

The environment 600 can include the HVAC system or otherwise be connected to the HVAC system. For instance, the environment 600 can include one or more HVAC modules 637. The HVAC modules 637 can be connected to one or more components of the HVAC system associated with a property. A module 637 can be configured to capture sensor data from, control operation of, or both, corresponding components of the HVAC system. In some implementations, the module 637 is configured to monitor energy consumption of an HVAC system component, for example, by directly measuring the energy consumption of the HVAC system components or by estimating the energy usage of the one or more HVAC system components by detecting usage of components of the HVAC system. The module 637 can communicate energy monitoring information, the state of the HVAC system components, or both, to the thermostat 634. The module 637 can control the one or more components of the HVAC system in response to receipt of commands received from the thermostat 634.

In some examples, the environment 600 includes one or more robotic devices 690. The robotic devices 690 can be any type of robots that are capable of moving, such as an aerial drone, a land-based robot, or a combination of both. The robotic devices 690 can take actions, such as capture sensor data or other actions that assist in security monitoring, property automation, or a combination of both. For example, the robotic devices 690 can include robots capable of moving throughout a property using automated navigation control technology, user input control provided by a user, or a combination of both. The robotic devices 690 can fly, roll, walk, or otherwise move about the property. The robotic devices 690 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 690 can be robotic devices 690 that are intended for other purposes and merely associated with the environment 600 for use in appropriate circumstances. For instance, a robotic vacuum cleaner device can be associated with the environment 600 as one of the robotic devices 690 and can be controlled to take action responsive to monitoring system events.

In some examples, the robotic devices 690 automatically navigate within a property. In these examples, the robotic devices 690 include sensors and control processors that guide movement of the robotic devices 690 within the property. For instance, the robotic devices 690 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 690 can include control processors that process output from the various sensors and control the robotic devices 690 to move along a path that reaches the desired destination, avoids obstacles, or a combination of both. In this regard, the control processors detect walls or other obstacles in the property and guide movement of the robotic devices 690 in a manner that avoids the walls and other obstacles.

In some implementations, the robotic devices 690 can store data that describes attributes of the property. For instance, the robotic devices 690 can store a floorplan, a three-dimensional model of the property, or a combination of both, that enable the robotic devices 690 to navigate the property. During initial configuration, the robotic devices 690 can receive the data describing attributes of the property, determine a frame of reference to the data (e.g., a property or reference location in the property), and navigate the property using the frame of reference and the data describing attributes of the property. In some examples, initial configuration of the robotic devices 690 can include learning one or more navigation patterns in which a user provides input to control the robotic devices 690 to perform a specific navigation action (e.g., fly to an upstairs bedroom and spin around while capturing video and then return to a property charging base). In this regard, the robotic devices 690 can learn and store the navigation patterns such that the robotic devices 690 can automatically repeat the specific navigation actions upon a later request.

In some examples, the robotic devices 690 can include data capture devices. In these examples, the robotic devices 690 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 690 to take and store a biometric sample that can be used to identify the person (e.g., a biometric sample with DNA that can be used for DNA testing).

In some implementations, the robotic devices 690 can include output devices. In these implementations, the robotic devices 690 can include one or more displays, one or more speakers, any other type of output devices that allow the robotic devices 690 to communicate information, e.g., to a nearby user or another type of person, or a combination of these.

The robotic devices 690 can include a communication module that enables the robotic devices 690 to communicate with the control unit 610, each other, other devices, or a combination of these. The communication module can be a wireless communication module that allows the robotic devices 690 to communicate wirelessly. For instance, the communication module can be a Wi-Fi module that enables the robotic devices 690 to communicate over a local wireless network at the property. Other types of short-range wireless communication protocols, such as 900 MHz wireless communication, Bluetooth, Bluetooth LE, Z-wave, Zigbee, M atter, or any other appropriate type of wireless communication, can be used to allow the robotic devices 690 to communicate with other devices, e.g., in or off the property. In some implementations, the robotic devices 690 can communicate with each other or with other devices of the environment 600 through the network 605.

The robotic devices 690 can include processor and storage capabilities. The robotic devices 690 can include any one or more suitable processing devices that enable the robotic devices 690 to execute instructions, operate applications, perform the actions described throughout this specification, or a combination of these. In some examples, the robotic devices 690 can include solid-state electronic storage that enables the robotic devices 690 to store applications, configuration data, collected sensor data, any other type of information available to the robotic devices 690, or a combination of two or more of these.

The robotic devices 690 can process captured data locally, provide captured data to one or more other devices for processing, e.g., the control unit 610 or the monitoring system 660, or a combination of both. For instance, the robotic device 690 can provide the images to the control unit 610 for processing. In some examples, the robotic device 690 can process the images to determine an identification of the items.

One or more of the robotic devices 690 can be associated with one or more charging stations. The charging stations can be located at a predefined home base or reference location in the property. The robotic devices 690 can be configured to navigate to one of the charging stations after completion of one or more tasks needed to be performed, e.g., for the environment 600. For instance, after completion of a monitoring operation or upon instruction by the control unit 610, a robotic device 690 can be configured to automatically fly to and connect with, e.g., land on, one of the charging stations. In this regard, a robotic device 690 can automatically recharge one or more batteries included in the robotic device 690 so that the robotic device 690 is less likely to need recharging when the environment 600 requires use of the robotic device 690, e.g., absent other concerns for the robotic device 690.

The charging stations can be contact-based charging stations, wireless charging stations, or a combination of both. For contact-based charging stations, the robotic devices 690 can have readily accessible points of contact to which a robotic device 690 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 690 can include a cover that opens to expose the electronic contact when the robotic device is charging and closes to cover and insulate the electronic contact when the robotic device 690 is in operation.

For wireless charging stations, the robotic devices 690 can charge through a wireless exchange of power. In these instances, a robotic device 690 needs only position itself closely enough to a wireless charging station for the wireless exchange of power to occur. In this regard, the positioning needed to land at a predefined home base or reference location in the property can be less precise than with a contact-based charging station. Based on the robotic devices 690 landing at a wireless charging station, the wireless charging station can output a wireless signal that the robotic device 690 receives and converts to a power signal that charges a battery maintained on the robotic device 690. As described in this specification, a robotic device 690 landing or coupling with a charging station can include a robotic device 690 positioning itself within a threshold distance of a wireless charging station such that the robotic device 690 is able to charge its battery.

In some implementations, one or more of the robotic devices 690 has an assigned charging station. In these implementations, the number of robotic devices 690 can equal the number of charging stations. In these implementations, the robotic devices 690 can always navigate to the specific charging station assigned to that robotic device 690. For instance, a first robotic device can always use a first charging station and a second robotic device can always use a second charging station.

In some examples, the robotic devices 690 can share charging stations. For instance, the robotic devices 690 can use one or more community charging stations that are capable of charging multiple robotic devices 690, e.g., substantially concurrently or separately or a combination of both at different times. The community charging station can be configured to charge multiple robotic devices 690 at substantially the same time, e.g., the community charging station can begin charging a first robotic device and then, while charging the first robotic device, begin charging a second robotic device five minutes later. The community charging station can be configured to charge multiple robotic devices 690 in serial such that the multiple robotic devices 690 take turns charging and, when fully charged, return to a predefined home base or reference location or another location in the property that is not associated with a charging station. The number of community charging stations can be less than the number of robotic devices 690.

In some instances, the charging stations might not be assigned to specific robotic devices 690 and can be capable of charging any of the robotic devices 690. In this regard, the robotic devices 690 can use any suitable, unoccupied charging station when not in use, e.g., when not performing an operation for the environment 600. For instance, when one of the robotic devices 690 has completed an operation or is in need of battery charge, the control unit 610 can reference a stored table of the occupancy status of each charging station and instructs the robotic device to navigate to the nearest charging station that has at least one unoccupied charger.

The environment 600 can include one or more integrated security devices 680. The one or more integrated security devices can include any type of device used to provide alerts based on received sensor data. For instance, the one or more control units 610 can provide one or more alerts to the one or more integrated security input/output devices 680. In some examples, the one or more control units 610 can receive sensor data from the sensors 620 and determine whether to provide an alert, or a message to cause presentation of an alert, to the one or more integrated security input/output devices 680.

The sensors 620, the module 622, the camera 630, the thermostat 634, the module 637, the integrated security devices 680, and the robotic devices 690, can communicate with the controller 612 over communication links 624, 626, 628, 632, 636, 638, 684, and 686. The communication links 624, 626, 628, 632, 636, 638, 684, and 686 can be a wired or wireless data pathway configured to transmit signals between any combination of the sensors 620, the module 622, the camera 630, the thermostat 634, the module 637, the integrated security devices 680, the robotic devices 690, or the controller 612. The sensors 620, the module 622, the camera 630, the thermostat 634, the module 637, the integrated security devices 680, and the robotic devices 690, can continuously transmit sensed values to the controller 612, periodically transmit sensed values to the controller 612, or transmit sensed values to the controller 612 in response to a change in a sensed value, a request, or both. In some implementations, the robotic devices 690 can communicate with the monitoring system 660 over network 605. The robotic devices 690 can connect and communicate with the monitoring system 660 using a Wi-Fi or a cellular connection or any other appropriate type of connection.

The communication links 624, 626, 628, 632, 636, 638, 684, and 686 can include any appropriate type of network, such as a local network. The sensors 620, the module 622, the camera 630, the thermostat 634, the robotic devices 690 and the integrated security devices 680, and the controller 612 can exchange data and commands over the network.

The monitoring system 660 can include one or more electronic devices, e.g., one or more computers. The monitoring system 660 is configured to provide monitoring services by exchanging electronic communications with the control unit 610, the one or more devices 640 and 650, the central alarm system 670, or a combination of these, over the network 605. For example, the monitoring system 660 can be configured to monitor events (e.g., alarm events) generated by the control unit 610. In this example, the monitoring system 660 can exchange electronic communications with the network module 614 included in the control unit 610 to receive information regarding events (e.g., alerts) detected by the control unit 610. The monitoring system 660 can receive information regarding events (e.g., alerts) from the one or more devices 640 and 650.

In some implementations, the monitoring system 660 might be configured to provide one or more services other than monitoring services. In these implementations, the monitoring system 660 might perform one or more operations described in this specification without providing any monitoring services, e.g., the monitoring system 660 might not be a monitoring system as described in the example shown in FIG. 6.

In some examples, the monitoring system 660 can route alert data received from the network module 614 or the one or more devices 640 and 650 to the central alarm system 670. For example, the monitoring system 660 can transmit the alert data to the central alarm system 670 over the network 605.

The monitoring system 660 can store sensor and image data received from the environment 600 and perform analysis of sensor and image data received from the environment 600. Based on the analysis, the monitoring system 660 can communicate with and control aspects of the control unit 610 or the one or more devices 640 and 650.

The monitoring system 660 can provide various monitoring services to the environment 600. For example, the monitoring system 660 can analyze the sensor, image, and other data to determine an activity pattern of a person of the property monitored by the environment 600. In some implementations, the monitoring system 660 can analyze the data for alarm conditions or can determine and perform actions at the property by issuing commands to one or more components of the environment 600, possibly through the control unit 610.

The central alarm system 670 is an electronic device, or multiple electronic devices, configured to provide alarm monitoring service by exchanging communications with the control unit 610, the one or more mobile devices 640 and 650, the monitoring system 660, or a combination of these, over the network 605. For example, the central alarm system 670 can be configured to monitor alerting events generated by the control unit 610. In this example, the central alarm system 670 can exchange communications with the network module 614 included in the control unit 610 to receive information regarding alerting events detected by the control unit 610. The central alarm system 670 can receive information regarding alerting events from the one or more mobile devices 640 and 650, the monitoring system 660, or both.

The central alarm system 670 is connected to multiple terminals 672 and 674. The terminals 672 and 674 can be used by operators to process alerting events. For example, the central alarm system 670, e.g., as part of a first responder system, can route alerting data to the terminals 672 and 674 to enable an operator to process the alerting data. The terminals 672 and 674 can include general-purpose computers (e.g., desktop personal computers, workstations, or laptop computers) that are configured to receive alerting data from a computer in the central alarm system 670 and render a display of information using the alerting data.

For instance, the controller 612 can control the network module 614 to transmit, to the central alarm system 670, alerting data indicating that a sensor 620 detected motion from a motion sensor via the sensors 620. The central alarm system 670 can receive the alerting data and route the alerting data to the terminal 672 for processing by an operator associated with the terminal 672. The terminal 672 can render a display to the operator that includes information associated with the alerting event (e.g., the lock sensor data, the motion sensor data, the contact sensor data, etc.) and the operator can handle the alerting event based on the displayed information. In some implementations, the terminals 672 and 674 can be mobile devices or devices designed for a specific function. Although FIG. 6 illustrates two terminals for brevity, actual implementations can include more (and, perhaps, many more) terminals.

The one or more devices 640 and 650 are devices that can present content, e.g., host and display user interfaces, audio data, or both. For instance, the mobile device 640 is a mobile device that hosts or runs one or more native applications (e.g., the smart property application 642). The mobile device 640 can be a cellular phone or a non-cellular locally networked device with a display. The mobile device 640 can include a cell phone, a smart phone, a tablet PC, a personal digital assistant (“PDA”), or any other portable device configured to communicate over a network and present information. The mobile device 640 can perform functions unrelated to the monitoring system, such as placing personal telephone calls, playing music, playing video, displaying pictures, browsing the Internet, and maintaining an electronic calendar.

The mobile device 640 can include a smart property application 642. The smart property application 642 refers to a software/firmware program running on the corresponding mobile device that enables the user interface and features described throughout. The mobile device 640 can load or install the smart property application 642 using data received over a network or data received from local media. The smart property application 642 enables the mobile device 640 to receive and process image and sensor data from the monitoring system 660.

The device 650 can be a general-purpose computer (e.g., a desktop personal computer, a workstation, or a laptop computer) that is configured to communicate with the monitoring system 660, the control unit 610, or both, over the network 605. The device 650 can be configured to display a smart property user interface 652 that is generated by the device 650 or generated by the monitoring system 660. For example, the device 650 can be configured to display a user interface (e.g., a web page) generated using data provided by the monitoring system 660 that enables a user to perceive images captured by the camera 630, reports related to the monitoring system, or both. Although FIG. 6 illustrates two devices for brevity, actual implementations can include more (and, perhaps, many more) or fewer devices.

In some implementations, the one or more devices 640 and 650 communicate with and receive data from the control unit 610 using the communication link 638. For instance, the one or more devices 640 and 650 can communicate with the control unit 610 using various wireless protocols, or wired protocols such as Ethernet and USB, to connect the one or more devices 640 and 650 to the control unit 610, e.g., local security and automation equipment. The one or more devices 640 and 650 can use a local network, a wide area network, or a combination of both, to communicate with other components in the environment 600. The one or more devices 640 and 650 can connect locally to the sensors and other devices in the environment 600.

Although the one or more devices 640 and 650 are shown as communicating with the control unit 610, the one or more devices 640 and 650 can communicate directly with the sensors and other devices controlled by the control unit 610. In some implementations, the one or more devices 640 and 650 replace the control unit 610 and perform one or more of the functions of the control unit 610 for local monitoring and long range, offsite, or both, communication.

In some implementations, the one or more devices 640 and 650 receive monitoring system data captured by the control unit 610 through the network 605. The one or more devices 640 and 650 can receive the data from the control unit 610 through the network 605, the monitoring system 660 can relay data received from the control unit 610 to the one or more devices 640 and 650 through the network 605, or a combination of both. In this regard, the monitoring system 660 can facilitate communication between the one or more devices 640 and 650 and various other components in the environment 600.

In some implementations, the one or more devices 640 and 650 can be configured to switch whether the one or more devices 640 and 650 communicate with the control unit 610 directly (e.g., through communication link 638) or through the monitoring system 660 (e.g., through network 605) based on a location of the one or more devices 640 and 650. For instance, when the one or more devices 640 and 650 are located close to, e.g., within a threshold distance of, the control unit 610 and in range to communicate directly with the control unit 610, the one or more devices 640 and 650 use direct communication. When the one or more devices 640 and 650 are located far from, e.g., outside the threshold distance of, the control unit 610 and not in range to communicate directly with the control unit 610, the one or more devices 640 and 650 use communication through the monitoring system 660.

Although the one or more devices 640 and 650 are shown as being connected to the network 605, in some implementations, the one or more devices 640 and 650 are not connected to the network 605. In these implementations, the one or more devices 640 and 650 communicate directly with one or more of the monitoring system components and no network (e.g., Internet) connection or reliance on remote servers is needed.

In some implementations, the one or more devices 640 and 650 are used in conjunction with only local sensors and/or local devices in a house. In these implementations, the environment 600 includes the one or more devices 640 and 650, the sensors 620, the module 622, the camera 630, and the robotic devices 690. The one or more devices 640 and 650 receive data directly from the sensors 620, the module 622, the camera 630, the robotic devices 690, or a combination of these, and send data directly to the sensors 620, the module 622, the camera 630, the robotic devices 690, or a combination of these. The one or more devices 640 and 650 can provide the appropriate interface, processing, or both, to provide visual surveillance and reporting using data received from the various other components.

In some implementations, the environment 600 includes network 605 and the sensors 620, the module 622, the camera 630, the thermostat 634, and the robotic devices 690 are configured to communicate sensor and image data to the one or more devices 640 and 650 over network 605. In some implementations, the sensors 620, the module 622, the camera 630, the thermostat 634, and the robotic devices 690 are programmed, e.g., intelligent enough, to change the communication pathway from a direct local pathway when the one or more devices 640 and 650 are in close physical proximity to the sensors 620, the module 622, the camera 630, the thermostat 634, the robotic devices 690, or a combination of these, to a pathway over network 605 when the one or more devices 640 and 650 are farther from the sensors 620, the module 622, the camera 630, the thermostat 634, the robotic devices 690, or a combination of these.

In some examples, the monitoring system 660 leverages GPS information from the one or more devices 640 and 650 to determine whether the one or more devices 640 and 650 are close enough to the sensors 620, the module 622, the camera 630, the thermostat 634, the robotic devices 690, or a combination of these, to use the direct local pathway or whether the one or more devices 640 and 650 are far enough from the sensors 620, the module 622, the camera 630, the thermostat 634, the robotic devices 690, or a combination of these, that the pathway over network 605 is required. In some examples, the monitoring system 660 leverages status communications (e.g., pinging) between the one or more devices 640 and 650 and the sensors 620, the module 622, the camera 630, the thermostat 634, the robotic devices 690, or a combination of these, to determine whether communication using the direct local pathway is possible. If communication using the direct local pathway is possible, the one or more devices 640 and 650 communicate with the sensors 620, the module 622, the camera 630, the thermostat 634, the robotic devices 690, or a combination of these, using the direct local pathway. If communication using the direct local pathway is not possible, the one or more devices 640 and 650 communicate with the sensors 620, the module 622, the camera 630, the thermostat 634, the robotic devices 690, or a combination of these, using the pathway over network 605.

In some implementations, the environment 600 provides people with access to images captured by the camera 630 to aid in decision-making. The environment 600 can transmit the images captured by the camera 630 over a network, e.g., a wireless WAN, to the devices 640 and 650. Because transmission over a network can be relatively expensive, the environment 600 can use several techniques to reduce costs while providing access to significant levels of useful visual information (e.g., compressing data, down-sampling data, sending data only over inexpensive LAN connections, or other techniques).

In some implementations, a state of the environment 600, one or more components in the environment 600, and other events sensed by a component in the environment 600 can be used to enable/disable video/image recording devices (e.g., the camera 630). In these implementations, the camera 630 can be set to capture images on a periodic basis when the alarm system is armed in an “away” state, set not to capture images when the alarm system is armed in a “stay” state or disarmed, or a combination of both. In some examples, the camera 630 can be triggered to begin capturing images when the control unit 610 detects an event, such as an alarm event, a door-opening event for a door that leads to an area within a field of view of the camera 630, or motion in the area within the field of view of the camera 630. In some implementations, the camera 630 can capture images continuously, but the captured images can be stored or transmitted over a network when needed.

Although FIG. 6 depicts the monitoring system 660 as remote from the control unit 610, in some examples the control unit 610 can be a component of the monitoring system 660. For instance, both the monitoring system 660 and the control unit 610 can be physically located at a property that includes the sensors 620 or at a location outside the property.

In some examples, some of the sensors 620, the robotic devices 690, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 610, the monitoring system 660, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible nontransitory program carrier for execution by, or to control the operation of, a data processing apparatus. Alternatively or in addition, the program instructions can be encoded on an artificiallygenerated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an applicationspecific integrated Circuit (“ASIC”).

Computers suitable for the execution of a computer program include, by way of example, general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computerreadable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the invention have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A system comprising one or more computers and one storage devices on which are stored instructions that are operable, when executed by the one or more computers, to cause the one or more computers to perform operations comprising:
receiving, from a sensor of a load control unit located at a property, power grid frequency data indicating a locally measured power grid frequency at the property;
determining, from the power grid frequency data, a grid frequency event; and
in response to the determined grid frequency event, generating, by the load control unit, control signals to adjust a setting of a load in data communication with the load control unit within a threshold distance of the property.

2. The system of claim 1, wherein receiving, from the sensor of the load control unit located at the property, the power grid frequency data comprises:
receiving, from a sensor of a thermostat of the property, the power grid frequency data, and wherein adjusting the setting of the load control unit comprises adjusting the setting of the thermostat.

3. The system of claim 2, wherein adjusting the setting of the thermostat further comprises:
generating, from the setting of the thermostat, control signals to adjust a set point offset or a mode of operation of an HVAC system in data communication with the thermostat; and
providing, to the HVAC system, the control signals.

4. The system of claim 1, wherein determining the grid frequency event comprises:
determining that the locally measured power grid frequency does not satisfy a frequency threshold value, and wherein adjusting the setting is responsive to determining that the locally measured power grid frequency does not satisfy the frequency threshold value.

5. The system of claim 1, wherein:
the power grid frequency data comprises a rate of change of frequency (ROCOF) value;
determining the grid frequency event comprises determining that the ROCOF value does not satisfy a threshold ROCOF value; and
adjusting the setting of the load control unit at the property is responsive to determining that the ROCOF value does not satisfy the threshold ROCOF value.

6. The system of claim 1, further comprising:
generating an alert responsive to the grid frequency event; and
providing, to one or more other load control units in a threshold vicinity of the sensor at the property, the alert responsive to the grid frequency event.

7. The system of claim 6, wherein providing the alert responsive to the grid frequency event comprises triggering an automated load control event for the one or more other load control units in the threshold vicinity of the sensor at the property including adjusting respective settings of each of the one or more other load control units.

8. The system of claim 6, wherein at least one of the one or more other load control units are located at a different property within the threshold vicinity of the property.

9. The system of claim 6, further comprising transmitting, to each of the one or more other load control units in the threshold vicinity of the sensor at the property, instructions to cause the other load control unit to perform an adjustment to a setting of the load control unit at a randomized time with respect to other adjustments for other load control units from the one or more other load control units.,
wherein the instructions include a randomized time delay in the adjustment with respect to each other adjustment for the one or more other load control units.

10. The system of claim 1, further comprising:
receiving, from the sensor at the property, updated power grid frequency data;
determining that the updated power grid frequency data satisfies a recovery frequency threshold value; and
in response to determining that the updated power grid frequency data satisfies the recovery frequency threshold value, updating a setting of the load control unit at the property.

11. The system of claim 1, wherein:
receiving the power grid frequency data indicating the locally measured power grid frequency at the property comprises receiving a first locally measured power grid frequency at a first point in time and a second locally measured power grid frequency at a second, later point in time, and
determining, from the power grid frequency data, the grid frequency event comprises determining, using both of the first and second locally measured power grid frequencies, the grid frequency event.

12. The system of claim 1, further comprising:
in response to determining the grid frequency event, implementing a delay in adjusting the setting of the load control unit at the property.

13. The system of claim 1, wherein adjusting the setting of the load control unit at the property comprises only adjusting the setting of a first load control unit at the property and determining to not adjust a setting of one or more other load control units at the property.

14. The system of claim 13, wherein only adjusting the setting of the first load control unit comprises only adjusting the setting of a load control unit configured to control operations of a low priority load and determining to not adjust a setting of a different load control unit configured to control operations of a high priority load.

15. The system of claim 1, further comprising:
receiving, from sensors corresponding to a plurality of properties, power grid frequency data indicating respective locally measured power grid frequency at each of the plurality of properties;
determining, from the respective locally measured power grid frequencies at each of the plurality of properties, a localized region including one or more properties of the plurality of properties experiencing the grid frequency event;
generating a localized power grid event alert including information of the localized region; and
providing the localized power grid event alert.

16. One or more computer storage media encoded with instructions that, when executed by one or more computers, cause the one or more computers to perform operations comprising:
receiving, from a sensor of a load control unit located at a property, power grid frequency data indicating a locally measured power grid frequency at the property;
determining, from the power grid frequency data, a grid frequency event; and
in response to the determined grid frequency event, generating, by the load control unit, control signals to adjust a setting of a load in data communication with the load control unit within a threshold distance of the property.

17. A computer-implemented method comprising:
receiving, by one or more processors of a load control unit and from a sensor of the load control unit located at a property, power grid frequency data indicating a locally measured power grid frequency at the property;
determining, by the one or more processors and from the power grid frequency data, a grid frequency event; and
in response to the determined grid frequency event, generating, by the one or more processors of the load control unit, control signals to adjust a setting of a load in data communication with the load control unit within a threshold distance of the property.
